(19) United States
(12) Patent Application Publication
(10) Pub. No.: US 2017/0275319 A1
(43) Pub. Date: Sep. 28, 2017

(54) PLATINUM DERIVATIVES FOR HYDROPHOBIC FORMULATIONS

(71) Applicant: Nemucore Medical Innovations, Inc., Worcester, MA (US)

(72) Inventor: Srinivas Ganta, Jamaica Plain, MA (US)

(21) Appl. No.: 15/481,068

(22) Filed: Apr. 6, 2017

Related U.S. Application Data
(63) Continuation of application No. 14/907,404, filed on Jan. 25, 2016, now abandoned.
(60) Provisional application No. 61/858,361, filed on Jul. 25, 2013.

(51) Int. Cl. C07F 15/00

(52) U.S. Cl. CPC C07F 15/0093

(57) ABSTRACT

New derivatives of a Pt (II) complex provided which are liposoluble and useful as anticancer agents. Also disclosed are platinum II complexes in delivery systems such as liposomes, emulsions, nanoemulsions, and lipid excipients.

### CROSS-REFERENCE TO RELATED APPLICATION

This application claims the benefit of U.S. Provisional Patent application Ser. No. 61/858,361, entitled “Platinum Derivatives For Hydrophobic Formulations and Preparation and Uses Thereof,” which was filed Jul. 25, 2013. The entirety of the aforementioned application is herein incorporated by reference.

### STATEMENT REGARDING FEDERALLY SPONSORED RESEARCH OR DEVELOPMENT

Part of the work leading to this invention was carried out with United States Government support provided under a grant from the National Institutes of Health, Grants No. R01CA158881, U54CA151881 and R43CA144591. Therefore, the U.S. Government has certain rights in this invention.

### FIELD OF THE INVENTION

The present disclosure relates to medicine and pharmacology, and more particularly, to cancer therapy.

### BACKGROUND

There are many treatment modalities for cancer, such as surgical operation, irradiation (radiotherapy), administration of chemical therapy (chemotherapy), immunological therapy (immunotherapy), and interferon therapy. However, in most cases these treatments do not cure the disease.

Surgery and radiotherapy, among others treatments, are locally applied techniques of therapy and are an effective means for treating patients only if the disease is localized to a specific part of the body or there is no metastasis. Therefore, these therapies are not as effective against progressive cancer, which often involves accompanying metastasis in the whole body of the patient, as well as the systematic diseases (such as leukemia, malignant lymphoma, lung, ovarian, breast, or other cancers) that gradually spread to the whole body. Chemotherapy is a somewhat effective therapy against such systematic diseases. Chemotherapy is also an effective tool for treating certain cancers, for example, when it is applied as an additional or auxiliary treatment after surgery and/or radiation.

Platinum (Pt) in certain chemical forms is a chemotherapeutic agent that is widely used in the treatment of cancers (see, e.g., Kelland (2007) Nature Rev. Cancer 7:573-582). Platinum-containing complexes inhibit the division of living cells and exert anticancer activity through several possible mechanisms, for example, by disrupting DNA structure in cell nuclei through the formation of intrastrand and interstrand cross-links (Rudd et al. (1995) Cancer Chemother. Pharmacol. 35(4)323-326). Cisplatin, the prototypical Pt (II) complex, has been used for the treatment of cancers since the 1970's (see, e.g., Wheate (2010) Royal Soc. Chem. 39:8113-8127).

However, clinical use of Pt (II) complexes is limited by their instability in aqueous solution, and their severe dose-limiting toxicities. Cisplatin for example, converts to an ineffective form in aqueous solution. Consequently, cisplatin solutions must be stabilized so that the drug will not lose its anti-tumor effectiveness (Sarker (2005) Curr. Drug Del. 2(4):297-310). Additionally, cisplatin is associated with moderate and severe adverse side-effects, including nausea, vomiting, abdominal pain, kidney damage, serum creatinine, hearing loss, and nephrotoxicity. The complex is used in the treatment of many diseases, for example, orchidoncus, bladder carcinoma, ovarian cancer, gynecological cancers, oophoroma, lung cancer, osteosarcoma, and cancer of the esophagus.

Additionally, despite advances in the design of chemotherapeutic agents and/or chemotherapeutic systems, formulation of platinum drugs into targeted nanocarriers and controlled-release vehicles of platinum drugs are still a challenge due to the physicochemical properties of platinum compounds. For many of the nanocarriers, lipophilicity is a parameter for design of novel platinum-based drugs and chemotherapeutic-targeted nanocarrier formulations, which are related to important biological processes such as absorption and transport through membranes.

In an effort to further progress platinum encapsulation, lipophilicity developments have been made in the nanocarrier field involving liposoluble Pt (II) complexes that utilize a di-fatty acid structure. For example, complexes such as cisplatin-dipalmitate and cisplatin-dimyristate have been developed allowing for platinum encapsulation in additional types of nanocarriers (see, U.S. Pat. No. 6,613,799). However, such di-fatty acid complexes are limited by their lipophilicity and thus limited in their suitability for administration in certain lipid emulsions, nanoemulsions.

Thus, there is a present unmet need for less toxic, more stable, more effective, and more selective platinum-containing chemotherapeutic agents and/or systems.

There is also a need in the field for platinum chemotherapeutic agents with improved lipophilicity capable of stable encapsulation in, or incorporation into additional types of nanoformulations.

### SUMMARY

It has been discovered that a certain platinum complex (Pt (II)) has improved lipophilicity and can be stably encapsulated in certain types of formulations which have therapeutic use. This discovery has been exploited to develop the present disclosure, which, in one aspect, provides a Pt (II) complex having the following general formula (I):

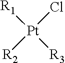

R₁ and R₂ are each an ammine and may be identical or different. Each of which may optionally have an organic substituent A:

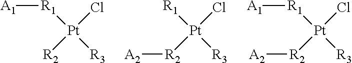

For example, the organic substituent A may be an alkyl group having 1 to 5 carbon atoms or a cycloalkyl group having 3 to 7 carbon atoms.

R₁ and R₂ may also be optionally linked via a bivalent organic group B:

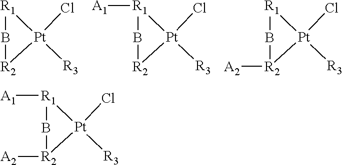

For example, the bivalent organic group B may be a cycloalkylene group, an alkylene group, a 1,2-cyclohexylene group, or a 1,2-phenylene group. Non-limiting examples of an alkylene group include an alkylene group having 2 to 3 carbon atoms, an alkylene group having 2 to 3 carbon atoms substituted with an alkyl group having 1 to 5 carbon atoms, and an alkylene group substituted with an alkyl group having 2 to 6 carbon atoms. Non-limiting examples of a 1,2-phenylene group include a 1,2-phenylene group substituted with an alkyl or an alkoxyl group having 1 to 5 carbon atoms, and a 1,2-phenylene group substituted with a halogen atom.

R₃ is a saturated or unsaturated fatty acid residue having 8 to 24 carbon atoms. For example, R₃ may be a myristic acid residue, a palmitic acid residue, or a stearic acid residue.

R₁, and R₂ are linked to the central platinum atom via coordinate bonds.

In another aspect, the disclosure provides a method of preparing the Pt (II) complex of the present disclosure. The method comprising the steps of reacting a cis-dichloro-di (substituted or unsubstituted) ammine Pt (II) complex of the formula (A):

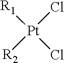

with a reagent (which may comprise rate limiting amounts of silver nitrate), to form a monohydrated and dihydrated intermediate complex. The resulting monohydrate and dihydrate complex intermediate are then reacted with a compound of the formula R₃-M (wherein R₃ has the same meaning as defined above and M comprises an alkali metal such as, but not limited to, sodium). The resulting liposoluble Pt (II) mono-fatty acid complex is then isolated using a separation solvent such as, but not limited to, one comprising chloroform.

The novel Pt (II) complex of the present disclosure inhibits the division and/or growth of living cells, and thus exhibits anticancer activity. Accordingly, in another aspect, the disclosure provides a method of treating cancer cells with an amount of the Pt (II) complex that is toxic to, or which inhibits the growth of, the cells. In one embodiment, the cancer being treated is in a mammal.

The Pt (II) complex of the present disclosure has improved lipophilicity and thus increased suitability for stable encapsulation and administration in certain additional lipid emulsions, nanoemulsions, liposomes, other suitable stable nanocarriers, and other hydrophobic formulations. Therefore, the present disclosure also provides a pharmaceutical composition comprising a therapeutically effective amount of the above mentioned Pt (II) complex and a pharmaceutically acceptable carrier therefore, and methods of treatment using such composition. As described above, encapsulation of platinum helps to mitigate the problems of excess toxicity and instability in the chemotherapeutic treatment of cancer patients. Therefore, by improving platinum lipophilicity and allowing for encapsulation in additional nanoformulations previously not available for platinum encapsulation, the present disclosure aids in the mitigation of these major obstacles.

### DESCRIPTION OF THE FIGURES

The foregoing and other objects of the present disclosure, the various features thereof, as well as the invention itself may be more fully understood from the following description, when read together with the accompanying drawings in which:

FIG. 1 is a schematic representation of a non-limiting scheme for preparing a Pt (II) complex of the present disclosure;

FIG. 2A is a representation of a RAMAN spectrum of cisplatin-monomyristate;

FIG. 2B is a representation of a RAMAN spectrum of cisplatin-monopalmitate;

FIG. 3A is a representation of an NMR spectrum of cisplatin-monomyristate;

FIG. 3B is a representation of an NMR spectrum of cisplatin-monopalmitate;

FIG. 3C is a representation of an NMR spectrum of cisplatin-monostearate; and

FIG. 4 is a graphic representation displaying the therapeutic efficacy of a Pt (II) mono-fatty acid complex of the present disclosure.

### DETAILED DESCRIPTION

Throughout this application, various patents, patent applications, and publications are referenced. The disclosures of these patents, patent applications, and publications in their entireties are hereby incorporated by reference into this application in order to more fully describe the state of the art as known to those skilled therein as of the date of the invention described and claimed herein. The instant disclosure will govern in the instance that there is any inconsistency between the patents, patent applications, and publications and this disclosure.

### Definitions

For convenience, certain terms employed in the specification, examples, and appended claims are collected here. Unless defined otherwise, all technical and scientific terms used herein have the same meaning as commonly understood by one of ordinary skill in the art to which this invention belongs. The initial definition provided for a group or term herein applies to that group or term throughout the present specification individually or as part of another group, unless otherwise indicated.

The articles “a” and “an” are used herein to refer to one or to more than one (i.e., to at least one) of the grammatical object of the article. By way of example, “an element” means one element or more than one element.

The term “or” is used herein to mean, and is used interchangeably with, the term “and/or,” unless context clearly indicates otherwise.

The term “about” is used herein to mean approximately, in the region of, roughly, or around. When the term “about” is used in conjunction with a numerical range, it modifies that range by extending the boundaries above and below the numerical values set forth. In general, the term “about” or “approximately” is used herein to modify a numerical value above and below the stated value by a variance of 20%.

“Anticancer agent” is an agent that prevents or inhibits the development, growth or proliferation of malignant cells.

“Treating cancer cells” is used herein to encompass inhibiting the growth of, or killing, a cancer cell or changing the oncogenic nature of a cancer cell towards normalcy.

“Cancer” is the uncontrolled growth of abnormal cells.

“Stable platinum-containing formulation” is a formulation containing a platinum-containing compound or ion wherein the compound or ion is stable for transformation for a time sufficient to be therapeutically useful.

“Stabilizer” is an agent that prevents or slows the transformation or deactivation of a platinum-containing compound or ion in a platinum-containing formulation.

“Patient” is a human or animal in need of treatment for cancer.

“DACH” Cylohexane-1,2-diammine

“Capryl” Caprylic acid residue (OCOC₇H₁₅)

“Cap” Capric acid residue (OCOC₉H₁₉)

“Lau” Lauric acid residue (OCOC₁₁H₂₃)

“Myr” Myristic acid residue (OCOC₁₃H₂₇)

“Pal” Palmitic acid residue (OCOC₁₅H₃₁)

“Ste” Stearic acid residue (OCOC₁₇H₃₅)

“Stol” Myristoleic acid residue (OCOC₁₃H₂₅)

“Tol” Palmitoleic acid residue (OCOC₁₅H₂₉)

“Sap” Sapienic acid residue (OCOC₁₅H₂₉)

“Oleic” Oleic acid residue (OCOC₁₇H₃₃)

“Ela” Elaidic acid residue (OCOC₁₇H₃₃)

“Vac” Vaccenic acid residue (OCOC₁₇H₃₃)

“CDDP” Cis-dichlorodiammine Pt (II)

“DACHP” Dichloro cyclohexane-1,2-diammine Pt (II)

An “organic substituent” is defined as a carbon atom or a carbon-containing molecule substituted for a hydrogen.

A “bivalent organic group” is defined as a carbon atom or carbon-containing molecule capable of forming two bonds with other atoms or molecules.

A “coordinate bond”, also known as a dipolar or dative covalent bond is a kind of 2-center, 2-electron covalent bond in which the two electrons are from the same atom.

The present disclosure relates to novel Pt (II) complexes, such as a liposoluble Pt (II) mono-fatty acid complex, having improved lipophilicity and stability and thus effective for therapeutic administration in certain pharmaceutical formulations comprising lipid emulsions, nanoemulsions, liposomes, nanocarriers, and hydrophobic formulations. These novel Pt (II) complexes are useful as anticancer agents. Such agents include other forms of Pt (II) complexes such as hydrophobic prodrugs, platinum polymer conjugates, and systems such as encapsulated Pt (II) complex nanocarrier formulations, which are more targeted due to the presence of targeting ligands and can be designed for controlled release. A process for preparing the novel Pt (II) complex of the present disclosure and methods of treatment using this complex are provided herein.

### 1. Pt (II) Complex

The present disclosure provides a Pt (II) complex having the following general formula (I):

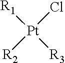

wherein:

R₁ and R₂ are each an ammine (NH₃) which optionally has an organic substituent A (A-NH₂):

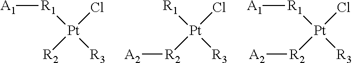

R₁ and R₂ may be identical or different, are linked to platinum via coordinate bonds, and optionally may be linked together via a bivalent organic group B (NH₂—B—NH₂):

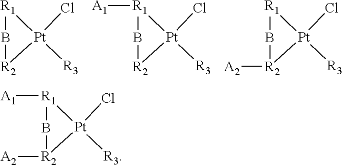

R₃ is a saturated or unsaturated fatty acid residue having 8 to 24 carbon atoms.

Possible non-limiting structural variations of the complex include a complex with no organic substituents and a bivalent organic group that may or may not be present; complex with an organic substituent attached to R₁ and a bivalent organic group that may or may not be present; a complex with an organic substituent attached to R₂ and a bivalent organic group that may or may not be present; and a complex with an organic substituent attached to both R₁ and R₂ and a bivalent organic group that may or may not be present.

Other non-limiting examples of the complex include ones in which the organic substituent (A) is a member selected from the group comprising alkyl groups having 1 to 5 carbon atoms, such as an isopropyl group, and cycloalkyl groups having 3 to 7 carbon atoms, such as a cyclohexyl group.

Other non-limiting examples of the complex include ones in which the bivalent organic group (B) is a member selected from the group comprising cycloalkylene groups; alkylene groups having 2 or 3 carbon atoms, eventually substituted with an alkyl group having 1 to 5 carbon atoms, an alkylene group having 2 to 6 carbon atoms, or phenyl group; and a 1, 2-phenylene group eventually substituted with an alkyl or alkoxyl having 1 to 5 carbon atoms or a halogen atom. Other non-limiting examples of the bivalent organic group include such groups as 1,2-cyclohexylene, 2,2-pentamethylene-trimethylene:

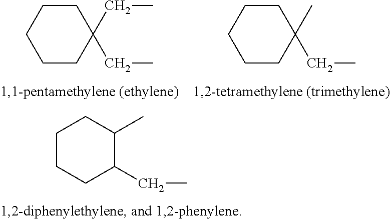

In the liposoluble Pt (II) complex according to the present disclosure, isomers, i.e., cis- and trans-form, are present when the bivalent organic group is 1,2-cyclohexylene or other such similar groups. In this respect, the complex of this disclosure may be in the form of cis or trans or the mixture thereof.

The substituent R₃ in the general formula (I) may be a saturated or unsaturated higher fatty acid having 8 to 24 carbon atoms. Non-limiting examples thereof are saturated fatty acids such as caprylic acid, capric acid, lauric acid, myristic acid, palmitic acid, and stearic acid, and unsaturated higher fatty acids having 8 to 24 carbon atoms, such as myristoleic acid, palmitoleic acid, sapienic acid, oleic acid, elaidic acid, and vaccenic acid.

### 2. Preparation of the Pt (II) Complex

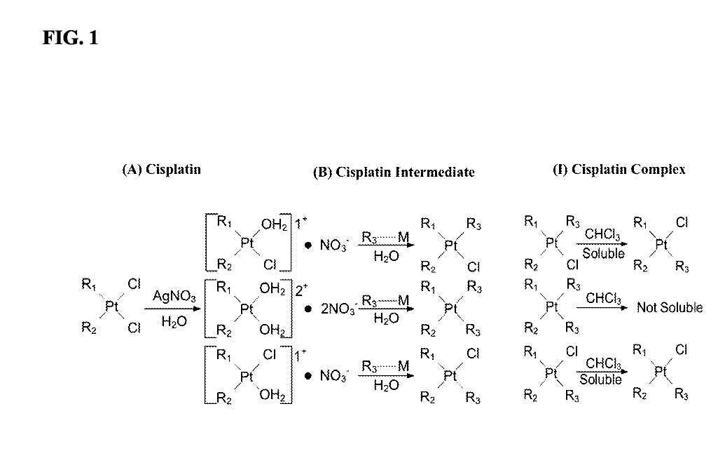

The liposoluble Pt (II) complex of the present disclosure, represented by the general formula (I), may be prepared according to the reaction scheme shown in FIG. 1.

According to this method, a cis-dichloro-diammine Pt (II) complex (A) (Connors et al. (1972) Chem. Biol. Interact. 5:415-424) is first converted to monohydrated or dihydrated intermediate complex by treatment with a 1:1 molar ratio of a suitable reagent and then the resulting intermediate (B) complexes are subjected to the reaction with a 1:1 molar ratio of a desired alkali metal salt of saturated or unsaturated higher fatty acid to form a saturated or unsaturated higher fatty acid derivative (I) of diammine Pt (II). This reaction results in the formation of both mono and di-fatty acid derivatives. Cisplatin mono-fatty acids are then separated out by dissolving the mixture in chloroform, in which mono-fatty acids are soluble but di-fatty acid derivatives are not. The first step of the reaction may be carried out using any suitable reagent such as silver nitrate (AgNO₃) that will form a halide that is insoluble in the reaction medium and the alkali metal used for the salt of the saturated or unsaturated higher fatty acid may be, but is not limited to, sodium or potassium.

The reaction in which the complex (A) is converted to the monohydrate or dihydrate complex intermediates (B) of the Pt (II) complex is performed under light-shielding conditions, and the reaction occurs in approximately 3 weeks at room temperature. To facilitate dissolution in a reaction medium, complex (A) is heated to approximately 70° C. prior to the addition of the second reagent.

The reaction (B)-(I) is also performed under light-shielding conditions, and takes approximately 3 weeks at room temperature to complete.

### 3. Solubility of the Pt (II) Complex

The Pt (II) complex thus obtained according to the method described herein is liposoluble, and thus is available for use as an anticancer agent having a high specificity and selectivity to cancer cells. Moreover, its liposolubility makes it possible to use the complex as a slowly and steadily released and sustained medicine. The complex may be combined with a carrier such as an emulsion, nanoemulsion or liposome to target it more specifically to a cancer in vivo.

In addition, as seen in Tables I and II, the liposolubility of the Pt (II) complex of the present disclosure is improved compared to that of the Pt (II) di-fatty acid complex because it has significantly improved lipophilicity with regard to certain compounds. Thus, it allows for platinum encapsulation in certain formulations of cancer treating lipid emulsions, nanoemulsions, liposomes, or other suitable stable nanocarriers for which platinum encapsulation was previously unavailable. The solubility of the Pt (II) di-fatty acid complex can be seen in Table I.

TABLE I
Solubility of Di-Fatty Acid Complex

| Compound | Water | CHCl₃ | DMC | THF | DMSO | MeOH | EtOH | ACN | DMF |
|---|---|---|---|---|---|---|---|---|---|
| Cisplatin- | − | ++ | − | − | − | + | − | − | + |
| dimyristate | | | | | | | | | |
| Cisplatin- | − | + | + | − | − | − | − | − | − |
| dipalmitate | | | | | | | | | |
| Cisplatin- | − | − | − | − | − | − | − | − | − |
| distearate | | | | | | | | | |
| Cisplatin- | − | − | − | − | − | − | − | − | |
| dioleate | | | | | | | | | |
| Cisplatin- | − | − | − | − | − | − | − | − | |
| dioctanoate | | | | | | | | | |
| Cisplatin- | − | − | − | − | − | − | − | − | |
| dilinoleate | | | | | | | | | |

The cisplatin di-fatty acid derivatives were found to have poor lipophilicity as shown in Table I. Formulations made with these compounds underwent destabilization during storage, as evidenced by phase separation and drug sediment formation. The poor lipophilicity of these compounds is due to the presence of a di-fatty acid structure, which causes them to be too hydrophobic.

The solubility of certain embodiments of the Pt (II) complex of the present disclosure can be seen in Table II (wherein the number of “+” signs indicate the degree of solubility and “−” indicates insoluble).

TABLE II
Solubility of Mono-Fatty Acid Complex

| Compound | Water | CHCI3 | DMC |
|---|---|---|---|
| Cisplatin-mono myristate | − | ++++ | + |
| Cisplatin-mono palmitate | − | ++++ | + |
| Cisplatin-mono stearate | − | ++++ | + |

In contrast, as seen in Table II, platinum derivatives with the mono-fatty acid structure of the present disclosure gave good lipophilicity, thus making them suitable for administration in additional types of lipid emulsions, nanoemulsions, liposome or other suitable stable nanocarriers. Nanoemulsion formulations prepared with a concentration of up to 5 mg/ml of cisplatin mono-myristate, cisplatin mono-palmitate, and cisplatin mono-stearate were stable at both 4° C. and room temperature for approximately 3 months.

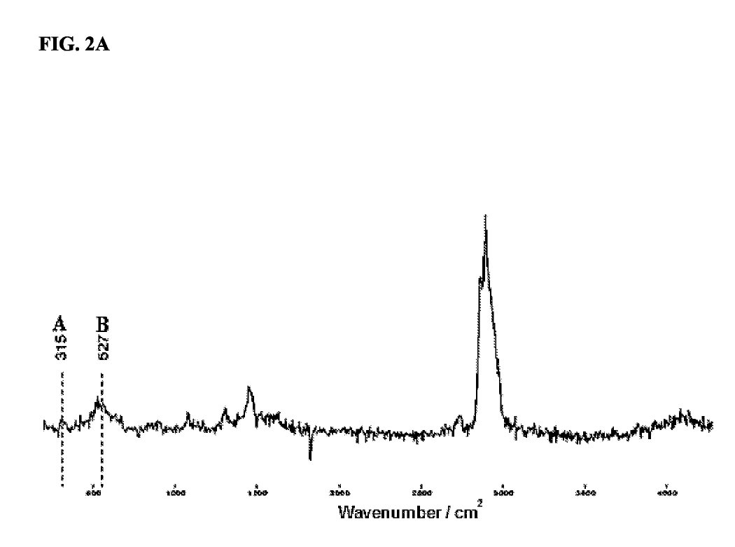

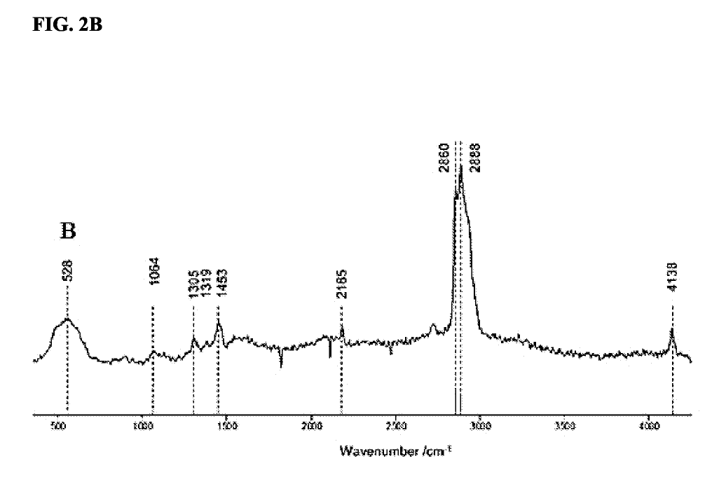

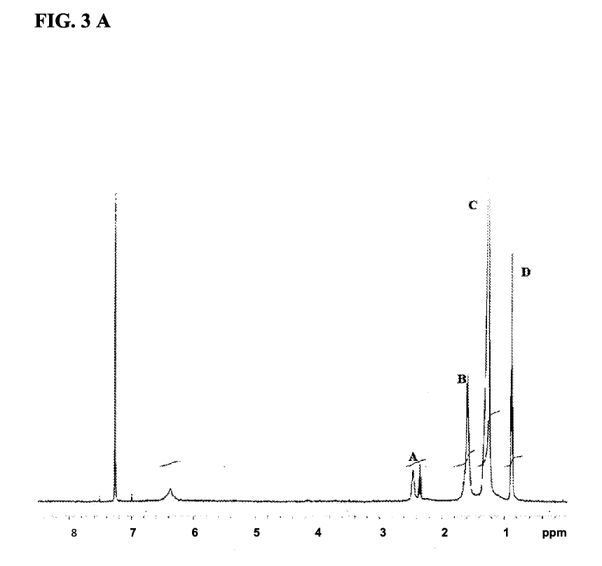

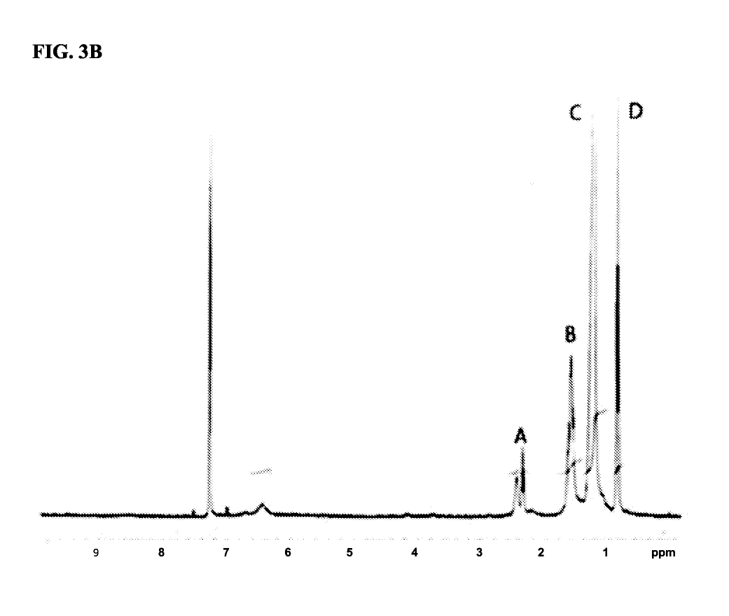

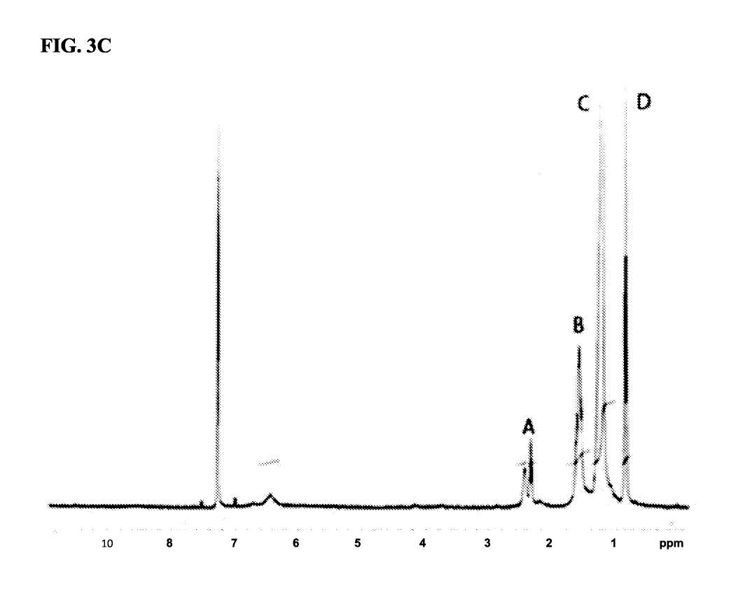

FIGS. 2A-B and FIGS. 3A-C delineate the RAMAN spectra and the NMR spectra, respectively, for particular embodiments of the Pt (II) complex of the present disclosure having the following general formula (I):

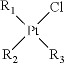

In these particular embodiments, a central platinum atom is bonded to one amino group (NH₂) in the R₁ position, one amino group (NH₂) in the R₂ position, one chlorine atom (Cl) as shown, and one myristic fatty acid chain (CH₃(CH₂)₁₂COOH), one palmitic fatty acid chain (CH₃(CH₂)₁₄COOH) or one stearic fatty acid chain (CH₃(CH₂)₁₆COOH) in the R₃ position, thus creating a Pt (II) mono-fatty acid complex. The FIGS. 2A-B RAMAN spectra confirms the presence of the one platinum-chlorine bond and the two platinum-nitrogen bonds for the Pt (II) mono-myristic fatty acid complex and Pt (II) mono-palmitic fatty acid complex, respectively. Peak A of the RAMAN spectrum corresponds to the platinum-chlorine bond and peak B corresponds to the two platinum-nitrogen bonds. The FIGS. 3 A-C NMR spectra confirm the structure of the myristic fatty acid chain, palmitic fatty acid chain, and the stearic fatty acid chain, respectively in the R₃ position. In FIG. 3A, peak A of the NMR spectrum corresponds to a CH₂ group of the myristic acid, peak B also corresponds to a CH₂ group, peak C corresponds to a (CH₂)₁₀ group, and peak D corresponds to a CH₃ group. In FIG. 3B, peak A of the NMR spectrum corresponds to a CH₂ group of the palmitic acid; peak B also corresponds to a CH₂ group; peak C corresponds to a (CH₂)₁₀ group; and peak D corresponds to a CH₃ group. In FIG. 3C, peak A of the NMR spectrum corresponds to a CH₂ group of the stearic acid; peak B also corresponds to a CH₂ group; peak C corresponds to a (CH₂)₁₀ group; and peak D corresponds to a CH₃ group.

### 4. Therapeutic Preparations of the Pt (II) Complex

Embodiments of the present disclosure involve a method of treating cancers, including but not limited to, leukemia, myclomas, mesotheliomas, cancers of the bronchial pathways, trachea, or esophagus, cancers of the liver or spleen, cancers of the ovary or testis, and cancers of the kidney, breast, or lung by intravenous, intramuscular, intraperitoneal, or subcutaneous delivery of platinum-containing formulations, or by inhalation of platinum-containing formulations.

The dose to be administered to a subject having a cancer can be determined by a physician based on the subject's age, the subject's physical condition, the sensitivity of the cancer to an antineoplastic agent, the nature of the cancer, and the stage and aggressiveness of the cancer. Generally the amount of an antineoplastic agent in a dose will be equal to or less than the corresponding dose administered intravenously. The procedures for determining cancer type and stage, sensitivity to an antineoplastic agent, and the tolerated dose for a subject which can be effective in treating the cancer are well known to physicians in the field of cancer treatment.

A pharmaceutical composition containing the Pt (II) complex may be administered to a cancer patient through intravenous or intraperitoneal injections, oral administration, or by means of applying on the cancerous skin. The composition may contain platinum compounds at a concentration of approximately 0.001%-2% (0.01 mg/ml-20 mg/ml). The dosage administered by injection may contain platinum in the range of about 5 mg-1000 mg in the first day of every 1 to 4 weeks depending upon the patient. A dosage of about 50 mg-400 mg can be administered the first day of every 1 to 4 weeks to a patient having a body weight of about 40 kg-100 kg. Such dosages may prove useful for patients having a body weight outside this range. The composition may also contain C₆-ceramide that acts as a proapoptotic agent, and enhances platinum cytotoxicity in the cancer cells. The concentration of C₆-ceramide in the composition is approximately 0.001%-2% (0.01 mg/ml-20 mg/ml).

The composition may also be administered orally, for example, as a liquid emulsion dosage form. Emulsion for oral administration are of about the same volume as those used for injection. However, when administering the drug orally, higher doses may be used when administering by injection. For example, a dosage containing about 10 mg-1500 mg platinum in the first day of every 1 to 4 weeks may be used. In preparing such liquid dosage form, standard making techniques may be employed.

### 5. Efficacy of the Pt (II) Complex

Because this novel Pt (II) complex is liposoluble, it has increased suitability for stable encapsulation and administration in certain additional lipid emulsions, nanoemulsions, liposomes, other suitable stable nanocarriers, and other suitable hydrophobic formulations creating a pharmaceutical formulation (Wheate, supra). Encapsulation of the Pt (II) complex of the present disclosure into a nanocarrier allows for targeting moieties to be attached to the nanocarrier. This creates a targeted and more efficient chemotherapeutic delivery system. Therefore, an encapsulated Pt (II) complex of the present disclosure reduces patient toxicity while still functioning to inhibit the division of cancer cells.

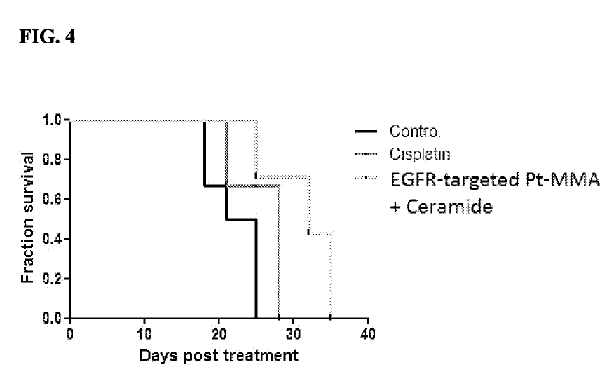

The therapeutic efficacy of the Pt (II) complex against cancer was examined in vivo according to the following procedure, the results of which can be seen both in Table III and in graphical form in FIG. 4. To develop orthotropic tumors, 30 Nu/Nu female mice, each weighing approximately 20 g (Charles River Laboratories, Cambridge, Mass.), were injected intraperitoneally (ip) with 1×10⁶ SKOV3 human ovary cancer cells (American Type Culture Collection (ATCC), Manassas, Va.) suspended in phosphate buffered saline. Animals were then dosed with nothing (control group) or test compounds. The formulation of cis-diamine Pt (II) chloride monomyristic acid (Pt-MMA) consisted of 20.8 mg/kg Pt-MMA+33.1 mg/kg ceramide using a 1:5 molar ratio and was encapsulated in an EGFR-targeted (EGFR-T) nanoemulsion, the preparation of which is described in the examples provided in this disclosure. Cisplatin was administered to mice as a comparative sample and its effectiveness was also examined. The doses of Pt-MMA (21 mg/kg) and cis-Platin (5 mg/kg) were calculated so that animals received equivalent amounts of Pt. Dosing began 39 days after tumor injection in cells when the tumors had reached a volume of 150 mm³-200 mm³ measured with a ruler.

Control or platinum compound treatment was administered on the 39th, 46th, 53th, 60th, and 66th day after initial tumor injections. The survival time of each group of mice was determined and the median survival time (days) was estimated on the basis of the observed survival time of each mouse. The therapeutic effectiveness of the Pt (II) complex is represented by the median survival significance compared to control (P-Value). The results are shown in Table III and FIG. 4.

TABLE III
Therapeutic Efficacy of Mono-Fatty Acid Pt (II) Complex

| | | Average | Average | Time for First | | Median Survival |
|---|---|---|---|---|---|---|
| | | Tumor | Tumor Size | Tumor to | Median | Significance |
| | Dose | Starting | at 21 Days | Reach 1000 mm³ | Survival | Compared to |
| Treatment | (mg/kg) | Size (mm³) | (mm³) | (days) | (days) | Control (P-Value) |
| Control | — | 166 ± 47 | 1071 ± 428 | 11 | 23 | — |
| Cisplatin | 5 | 171 ± 43 | 640 ± 314 | 17 | 28 | 0.0606 |
| EGFR-T Pt- | 21 | 167 ± 49 | 688 ± 288 | 21 | 32 | 0.0044 |
| MMA CER NE | | | | | | |

As the results show, the fractional survival for groups treated with the EGFR-targeted nanoemulsion formulation of the present disclosure significantly improved median survival as compared to that of the control and free cisplatin group and allowed for a higher allowable dosage as compared to that of cisplatin. These results were achieved because the Pt-MMA formulation had a lipophilicity that allowed for encapsulation in a nanocarrier while cisplatin did not. This encapsulation led to significantly lower system toxicity and thus a higher allowable dosage. This ability to administer the EGFR-targeted Pt-MMA CER formulation at higher doses than cisplatin led to increased efficacy as seen in Table III and in FIG. 4. The median survival for groups treated with the EGFR-targeted Pt-MMA CER formulation was significantly improved compared to that of the control group. The cisplatin group was not significantly improved compared to that of the control group. The encapsulation ability of the EGFR-targeted Pt-MMA CER formulation allowed for higher doses and thus more effective anticancer activity than the non-encapsulated cisplatin, and corroborates the interrelationship between anticancer activity and liposolubility/encapsulation potential.

The effect of cisplatin and the Pt (II) complex on the viability of ovarian SKOV3 cells was examined by inhibitory concentration analysis. The data were obtained using a tetrazolium assay which measures the activity of cellular enzymes that reduces the 3-(4,5-dimethylthiazol-2-yl)-2,5-diphenyltetrazolium bromide (MTT) dye to its insoluble formazan, giving a purple color. Ovarian SKOV3 cancer cells were treated with corresponding control solutions or test formulations. Polyethylenimine at 50 μg/ml was used as a positive control. The effect of ceramide in solution, a ceramide-containing nanoemulsion, and an EGFR-targeted ceramide Pt (II) complex nanoemulsion on the viability of ovarian SKOV3 cells was tested. In addition, the effect of a nanoemulsion containing a combination of the platinum derivative and ceramide in the ratio of 1:5 on the viability of ovarian SKOV3 cells was also tested.

Different nanoemulsion formulations containing the Pt (II) complex were made using a Microfluidizer (Microfluidics Corp., Newton, Mass.). The particle size of these resulting formulations, as determined using dynamic light scattering (DLS), and confirmed by transmission electron microscopy (TEM), was below 100 nM. The effect of the various nanoemulsion formulations on the viability of the ovarian SKOV3 cells was measured after 72 hours. Values are shown as mean±SD, n=8. All inhibitory concentration values were obtained from Graphpad Prism 5 scientific data analysis software.

The results are shown in Table IV.

TABLE IV
Inhibition of Growth of SKOV-3 Ovarian
Cells Inhibitory Concentration Analysis

| Treatment | IC₅₀ (nM) |
|---|---|
| Cisplatin in solution | 18,7000 ± 110 |
| Pt-MMA nanoemulsion | 19,500 ± 100 |
| Pt-MMA-targeted nanoemulsion | 2,400 ± 110 |
| Pt-MPA nanoemulsion | 13,000 ± 130 |
| Pt-MPA-targeted nanoemulsion | 4,300 ± 100 |
| Pt-MSA nanoemulsion | 529 |

As shown above, the inhibitory concentration of the nanoemulsions decreased significantly with the addition of the platinum derivative Pt-MMA, Pt-MPA or Pt-MSA. Additionally, the inhibitory concentration decreased significantly with the addition of Pt-MMA, or Pt-MPA in a targeted nanoemulsion. These data indicate the anticancer effect of the Pt (II) complex. The control solution and control nanoemulsions did not affect cell viability. 50%-60% of the cell death was noted with the positive control.

The Pt (II) complex of the present disclosure is thus useful as an anticancer agent.

Reference will now be made to specific examples illustrating the disclosure. It is to be understood that the examples are provided to illustrate exemplary embodiments and that no limitation to the scope of the disclosure is intended thereby.

### EXAMPLES

### Example 1

### Synthesis of cis-Diamine Pt (II) Chloride Monomyristic Acid (Pt-MMA)

The cisplatin intermediate was prepared as follows: Cis-dichlorodiamine Pt (II) (Sigma, St. Louis, Mo.) (240 mg, 0.8 mmoles) was suspended in 30 ml distilled water and heated to 70° C. to dissolve the complex. The solution was then cooled to room temperature (RT). Thereafter, an aqueous solution of silver nitrate (Sigma) (135.9 mg, 0.8 mmoles) in 10 ml of water was added drop-wise to the solution of starting material under stirring (400 rpm). The formation of translucent white precipitate of silver chloride was commenced immediately after the addition of the aqueous solution. The mixed solution was stirred for 3 hr at RT under light shielding conditions. The resulting precipitate of silver chloride was filtered off (Corning polystyrene Filter System, Corning, Amsterdam, Netherlands) (0.22 μM) and washed with water. The combined filtrate was used in the following step without further treatment.

Sodium myristate (Sigma) (200 mg, 0.8 mmoles) in 10 ml of water was added to the aqueous solution obtained above and stirred at RT for 3 weeks under light shielding condition to complete the reaction there between.

The translucent white precipitate formed was filtered off, washed with a small amount of ether, and dried in a vacuum desiccator to obtain the crude product. The crude product consisted of a mixture of mono- and di-fatty acid platinum derivatives. Because the mono-fatty acid platinum derivative was soluble in chloroform, chloroform was used to purify the mixture. The crude product was suspended in 25 ml chloroform in conical tube, vortex mixed for 5 min, and kept at RT for 24 hr. Tubes were then centrifuged (5000 rpm, 10 min), and the supernatant was transferred into glass vials and vacuum dried to obtain the dry Pt (II) monomyristic acid complex (yield=24.8%).

### Example 2

### Synthesis of cis-Diamine Pt (II) Chloride Monopalmitic Acid (Pt-MPA)

The cisplatin intermediate was prepared as follows. Cis-dichlorodiamine Pt (II) (240 mg, 0.8 mmoles) (Sigma) was suspended in 30 ml distilled water and heated to 70° C. to dissolve the complex. The solution was then cooled to RT. Thereafter, an aqueous solution of silver nitrate ((135.9 mg, 0.8 mmoles) in 10 ml of water) was added drop-wise to the solution of starting material under stirring (400 rpm). The formation of translucent white precipitate of silver chloride was commenced immediately after the addition of the aqueous solution. The mixed solution was stirred for 3 hr at RT under light shielding conditions. The resulting precipitate of silver chloride was filtered (Corning polystyrene Filter System, Corning) (0.22 μM) and washed with water. The combined filtrate was used in the following step without further treatment.

The Pt (II) monopalmitate complex was prepared as follows. An aqueous solution of sodium palmitate ((223 mg, 0.8 mmoles) (Sigma) in 10 ml of water) was added to the aqueous solution obtained above and stirred at RT for 3 weeks under light shielding conditions to complete the reaction there between. The translucent white precipitate formed was filtered off, washed with a small amount of ether, and dried in a vacuum desiccator to obtain the crude product. The crude product contained a mixture of mono- and di-fatty acid platinum derivatives. Because the mono-fatty acid platinum derivative was soluble in chloroform, chloroform was used to purify the mixture. The crude product was suspended in 25 ml chloroform in conical tube, vortex mixed for 5 min, and kept at RT for 24 hr. Tubes were then centrifuged (5000 rpm, 10 min) (Beckman Coulter, Inc., Brea, Calif.), and the supernatant was transferred into glass vials and vacuum dried to obtain the Pt (II) monomyristic acid complex (yield=22%).

### Example 3

### Synthesis of cis-Diamine Pt (II) Chloride Monostearic Acid (Pt-MSA)

The cisplatin intermediate was prepared as follows. Cis-dichlorodiamine Pt (II) (240 mg, 0.8 mmoles) (Sigma) was suspended in 30 ml distilled water and heated to 70° C. to dissolve the complex. The solution was then cooled to RT. Thereafter, aqueous solution of silver nitrate ((135.9 mg, 0.8 mmoles) in 10 ml of water) was added drop-wise to the solution of starting material under stirring (400 rpm). The formation of translucent white precipitate of silver chloride was commenced immediately after the addition of the aqueous solution. The mixed solution was stirred for 3 hr at RT under light shielding conditions. The resulting precipitate of silver chloride was filtered off (Corning polystyrene Filter System, Corning) (0.22 μM) and washed with water. The combined filtrate was used in the following step without further treatment.

The Pt (II) monostearate complex was prepared as follows. To an aqueous solution of sodium stearate ((245.15 mg, 0.8 mmoles) (Sigma) in 10 ml of water) was added the aqueous solution obtained above and stirred at RT for 3 weeks under light shielding conditions to complete the reaction. The translucent white precipitate formed was filtered off, washed with a small amount of ether, and dried in vacuum desiccator to obtain the crude product.

Because the crude product contained a mixture of mono- and di-fatty acid platinum derivatives, and the mono-fatty acid platinum derivative was soluble in chloroform, chloroform was used to purify the mixture. The crude product was suspended in 25 ml chloroform in conical tube, vortex mixed for 5 min, and kept at RT for 24 hr. Tubes were then centrifuged (5000 rpm, 10 min) (Beckman Coulter, Inc.), and the supernatant was carefully transferred into glass vials and vacuum dried to obtain the Pt-MSA complex (yield=6.08%).

### Example 4

### Production of cis-Diamine Pt (II) Chloride Monomyristate Acid (Pt-MMA) Nanoemulsion

The oil phase of this oil-in-water nanoemulsion was prepared as follows. 20.8 mg of platinum monomyristate (Pt-MMA) was dissolved in chloroform (extra dry) in a glass scintillation vial. 20.8 mg of Pt-MMA is equivalent to 5 mg of cisplatin based on Inductively Coupled Plasma Mass Spectrometry (ICP-MS) analysis. ICP-MS is a type of mass spectrometry which is capable of detecting metals and several non-metals at concentrations as low as one part in 1012 (part per trillion). This was achieved by ionizing the sample with inductively coupled plasma and then using a mass spectrometer to separate and quantify those ions.). Flax seed oil (1 g) was placed in a scintillation glass vial. Pt-MMA solution was added and nitrogen gas was blown on the sample to evaporate chloroform and to form the oil phase.

The aqueous phase of this oil-in-water nanoemulsion was prepared as follows. 120 mg egg lecithin (Lipoid E 80, Lipoid GMBH, Ludwigshafen, Germany), 15 mg PEG2000DSPE (Genzyme, Cambridge, Mass.) was added to 4 ml of 2.21% w/v glycerol (Sigma) solution in a glass scintillation vial made in water for injection. The mixture was stirred (400 rpm, Corning Stirrer plate) for 1 hr to achieve complete dissolution of these excipients.

The aqueous and oil phases from above steps were heated to 60° C. for 2 min in a water bath, and the aqueous phase was added to the oil phase, and vortex mixed for 1 min. The resulting mixture was passed through a LV1 Microfluidizer (Microfluidics Corp.) at 25,000 psi for 10 cycles, resulting in the production of a stable cis-diamine Pt (II) chloride monomyristate acid (Pt-MMA) nanoemulsion.

### Example 5

### Production of cis-Diamine Pt (II) Chloride Monopalmitic Acid (Pt-MPA) Nanoemulsion

The oil phase of this oil-in-water nanoemulsion was prepared as follows. Platinum monopalmitic (Pt-MPA) (20.8 mg, equivalent to 5 mg of cisplatin based on ICP-MS analysis) was dissolved in chloroform (extra dry) in a glass scintillation vial. Flax seed oil (1 g) was weighted into a scintillation glass vial to which the Pt-MPA solution was added. Nitrogen gas was then blown on the sample to evaporate chloroform and to form the oil phase.

The aqueous phase of this oil-in-water nanoemulsion was prepared as follows. 120 mg egg lecithin (Lipoid E 80, Lipoid GMBH) and 15 mg PEG2000DSPE (Genzyme) were added to 4 ml of 2.21% w/v glycerol (Sigma) solution in a glass scintillation vial made in water for injection. The mixture was stirred (400 rpm, Corning Stirrer plate) for 1 hr to achieve complete dissolution of these excipients.

The aqueous and oil phases from above steps were heated to 60° C. for 2 min in a water bath, and then the aqueous phase was added to the oil phase, and vortex mixed for 1 min. The resulting mixture was passed through a LV1 Microfluidizer (Microfluidics Corp.) at 25,000 psi for 10 cycles, resulting in the production of a stable cis-diamine Pt (II) chloride monopalmitic acid Pt-MPA nanoemulsion.

### Example 6

### Production of cis-Diamine Pt (II) Chloride Monostearic Acid (Pt-MSA) Nanoemulsion

The oil phase of this oil-in-water nanoemulsion was prepared as follows. Platinum monomyristate (Pt-MSA) (20.8 mg, equivalent to 5 mg of cisplatin based on ICP-MS analysis) was dissolved in chloroform (extra dry) in a glass scintillation vial. Flax seed oil (1 g) was weighted into a scintillation glass vial. Pt-MSA solution was added to flax seed oil and nitrogen gas was blown on the sample to evaporate chloroform and to form the oil phase.

The aqueous phase of this oil-in-water nanoemulsion was prepared as follows. 120 mg egg lecithin (Lipoid E 80, Lipoid GMBH), 15 mg PEG2000DSPE (Genzyme) were added to 4 ml of 2.21% w/v glycerol (Sigma) solution in a glass scintillation vial made in water for injection. The mixture was stirred (400 rpm) for 1 hr to achieve complete dissolution of these excipients.

The aqueous and oil phases from above steps were heated to 60° C. for 2 min in a water bath, and then the aqueous phase was added to the oil phase, and vortex mixed for 1 min. The resulting mixture was passed through a LV1 Microfluidizer (Microfluidics Corp.) at 25,000 psi for 10 cycles, resulting in the production of a stable cis-diamine Pt (II) chloride monostearate acid (Pt-MSA) nanoemulsion.

### EQUIVALENTS

Those skilled in the art will recognize, or be able to ascertain, using no more than routine experimentation, numerous equivalents to the specific embodiments described specifically herein. Such equivalents are intended to be encompassed in the scope of the following claims.

What is claimed is:

1. A Pt (II) complex having the following general formula (I): 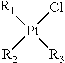
wherein:
R₁ and R₂ are each an ammine (NH₃) which optionally has an organic substituent A, (A-NH₂): 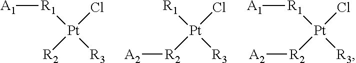
R₁ and R₂ being identical or different, being linked to platinum via coordinate bonds, and optionally being linked to each other via a bivalent organic group B (NH₂—B—NH₂): 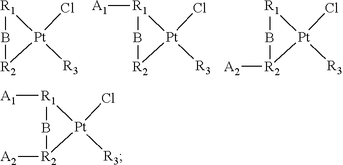
and
R₃ is a saturated or unsaturated fatty acid residue having 8 to 24 carbon atoms.

2. The Pt (II) complex of claim 1, wherein the organic substituent A is an alkyl group having 1 to 5 carbon atoms or is a cycloalkyl group having 3 to 7 carbon atoms.

3. The Pt (II) complex of claim 1, wherein the bivalent organic group B is a cycloalkylene group, an alkylene group, or a 1,2-phenylene group.

4. The Pt (II) complex of claim 3, wherein the bivalent organic group B is an alkylene group having 2 to 3 carbon atoms, an alkylene group having 2 to 3 carbon atoms substituted with an alkyl group having 1 to 5 carbon atoms, or an alkylene group substituted with an alkyl group having 2 to 6 carbon atoms.

5. The Pt (II) complex of claim 3, wherein the bivalent organic group B is a 1,2-phenypene group, a 1,2-phenylene group substituted with an alkyl or an alkoxyl group having 1 to 5 carbon atoms, or is a 1,2-phenylene group substituted with a halogen atom.

6. The Pt (II) complex of claim 1, wherein R₁ and R₂ are each an unsubstituted ammine (NH₃) group.

7. The Pt (II) complex of claim 1, wherein the bivalent organic group B is an 1,2-cyclohexylene group.

8. The Pt (II) complex of claim 1, wherein R₃ is a myristic acid residue, a palmitic acid residue, or a stearic acid residue.

9. A method of treating cancer cells, comprising contacting the cells with an amount of the Pt (II) complex of claim 1 that is toxic to, or which inhibits the growth of, the cells.

10. The method of claim 9, wherein the cells are in a mammal and the contacting step comprises administering to a mammal a therapeutically effective amount of the Pt (II) complex.
